(19) United States
(12) Patent Application Publication
(10) Pub. No.: US 2010/0083174 A1
(43) Pub. Date: Apr. 1, 2010

(54) PORTABLE TERMINAL AND METHOD FOR DISPLAYING CONTENTS LIST THEREOF

(75) Inventors: Myeong Lo Lee, Seoul (KR); Jung Yeob Oh, Seongnam-si (KR); Seung Woo Shin, Seoul (KR); Kyung Hwa Kim, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/554,335

(22) Filed: Sep. 4, 2009

(30) Foreign Application Priority Data
Sep. 26, 2008 (KR) 10-2008-0094882

(51) Int. Cl. G06F 3/048

(52) U.S. Cl. 715/810

(57) ABSTRACT

The present invention relates to a portable terminal and method of displaying a content list using the same. A content list may be classified into groups according to a classification criterion corresponding to an arrangement method selected by a user. The classified groups may be displayed to be visually distinguishable. A first group belonging to the classified groups may be displayed with a background in a first color. The background of a second group may be displayed in a second color different from the first color, and a background of a third group may be displayed in the first color. Accordingly, a user can easily recognize that attribute information associated with the content has changed.

### CROSS REFERENCE TO RELATED APPLICATION

This application claims priority from and the benefit of Korean patent application No. 10-2008-0094882, filed on Sep. 26, 2008, which is hereby incorporated by reference for all purposes as if fully set forth herein.

### BACKGROUND OF THE INVENTION

1. Field of the Invention

Exemplary embodiments of the present invention relate to a portable terminal and a method of displaying a content list using the same. In particular, the method classifies content into groups according to a given classification criterion, and displays each group in a visually distinguishable manner.

2. Description of the Background

With the rapid development of technology, a portable terminal may now include a variety of supplementary functions, such as transmission and reception of text messages, acquiring and storing pictures, listening to music, broadcasting digital service, as well as other communication functions. Furthermore, portable terminals may now store large quantities of content with the help of increased memory capacity. The content can include, for example, photos, telephone numbers, text messages, music files, and video files.

Meanwhile, according to a portable terminal user's request, the portable terminal may arrange and display the content in a list using a default arrangement method or an arrangement method selected by the user. For example, the content can be arranged and displayed chronologically, or can be arranged and displayed in an order of the content names (e.g., alphabetically). Currently, conventional portable terminals may output letters in a content list using the same color, and provide the same background color for all listed content. For example, the method of displaying a content list of the conventional portable terminal may be disadvantageous in that the portable terminal user may need to check the attribute information of the contents to distinguish content used today from content used yesterday.

### SUMMARY OF THE INVENTION

Exemplary embodiments of the present invention provide a portable terminal and a method of displaying a content list using the same. The method classifies a content list into groups according to a classification criterion which is preset in response to an arrangement method, and displays the content list so that a user can visually recognize the classified groups.

Additional features of the invention will be set forth in the description which follows, and in part will be apparent from the description, or may be learned by practice of the invention.

Exemplary embodiments of the present invention disclose a method of displaying a content list of a portable terminal. The method includes setting an arrangement method of arranging the content list in response to a request for displaying the content list. The content list includes a list of content. The method further includes classifying the content list into one or more groups according to a classification criterion associated with the arrangement method, and displaying the content list. The classified one or more groups are visually distinguishable from each other.

Exemplary embodiments of the present invention disclose a portable terminal. The portable terminal includes a controller and a display unit. The controller sets an arrangement method and classifies a content list into one or more groups according to a classification criterion associated with the arrangement method in response to a request of displaying the content list. The content list includes a list of content. The display unit displays the content list to visually distinguish the one or more groups from each other. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram showing a schematic configuration of a portable terminal according to exemplary embodiments of the present invention.

FIG. 2 is a flowchart schematically illustrating a method of setting up a background color of a contents list according to exemplary embodiments of the present invention.

FIG. 3 is an exemplary view showing a screen implemented according to the method of FIG. 2 according to exemplary embodiments of the present invention.

FIG. 4 is a flowchart illustrating a method of displaying a contents list according to exemplary embodiments of the present invention.

FIG. 5A, FIG. 5B, FIG. 5C, and FIG. 5D are exemplary views showing screens implemented according to the method of FIG. 4 according to exemplary embodiments of the present invention.

### DETAILED DESCRIPTION OF ILLUSTRATED EMBODIMENTS

Exemplary embodiments of the present invention are described with reference to the accompanying drawings in detail. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. The same reference numbers are used throughout the drawings to refer to the same or like parts. Detailed descriptions of well-known functions and structures incorporated herein may be omitted to avoid obscuring the subject matter of the present invention.

Exemplary embodiments disclosed in the present specification and drawings are illustrated to present specific examples in order to clarify the technical content of the present invention and help understanding of the present invention, but are not intended to limit the scope of the present invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Prior to explaining exemplary embodiments of the present invention, relevant terminology will be defined for the description below.

A portable terminal may refer to any information communication device and multimedia device, such as, for example, a mobile communication terminal, a mobile phone, a Personal Digital Assistant (PDA), Smart Phone, an International Mobile Telecommunication 2000 (IMT-2000) terminal, a Universal Mobile Telecommunication Service (UMTS) terminal, a Personnel Computer (PC), a notebook computer, and a digital broadcasting terminal. However, exemplary embodiments of the present invention may not be limited to such devices and terminals.

Content may refer to digital information provided through a variety of wired/wireless communication networks. The term content may be used to indicate all information provided by the portable terminal, or content thereof. For example, the content may include, but not be limited to, phone call logs, telephone numbers, music files, video files, text messages, and image files.

The content list may list and display the content stored in the portable terminal according to their titles (names), icons, or thumbnail images. In general, the content list may be displayed according to an arrangement method set by a user, such as a name, time, and/or a capacity.

Content list background may refer to a background for displaying content titles, icons, or images in a region (e.g., a frame of square shape). The content list background may exclude the content titles, icons, or images.

Classification criterion may refer to a criterion for classifying content into groups. The classification criterion can be changed according to a method of arranging content lists. For example, if the method of arranging content lists is based on time, the classification criterion can be a date. That is, the portable terminal can check date information of content and classify the content having the same date information into one group.

Hereinafter, exemplary embodiments of the present invention are described in detail with reference to the accompanying drawings.

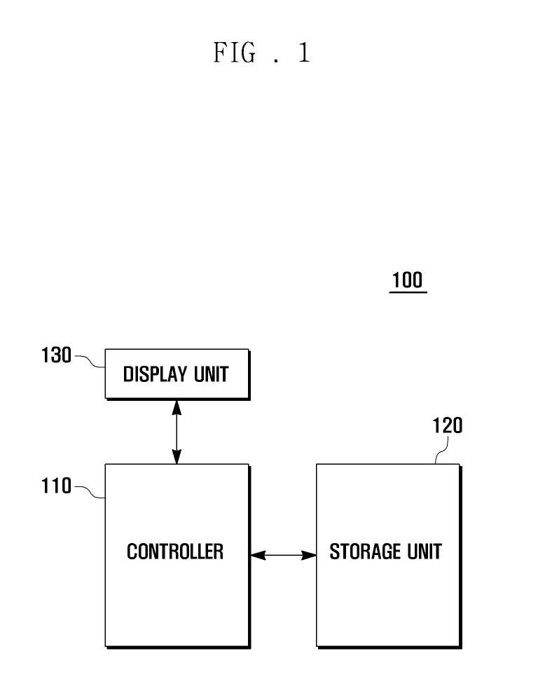

FIG. 1 is a block diagram showing a schematic configuration of a portable terminal according to exemplary embodiments of the present invention.

Referring to FIG. 1, the portable terminal 100 may include a controller 110, a storage unit 120, and a display unit 130 according to exemplary embodiments of the present invention.

The display unit 130 can display user data, function setting information, and various information provided to a user of the portable terminal 100. The display unit 130 may also display a variety of menu screens of the portable terminal 100. The user data may be input by the user. The display unit 130 can be implemented using a Liquid Crystal Display (LCD), Organic Light Emitting Diodes (OLED), or the like. Furthermore, when the display unit 130 includes a touch screen, the display unit 130 can operate as an input means.

The display unit 130 can display a content list to show content stored in the portable terminal 100 at the request of the user. Further, the display unit 130 can arrange and display the content list according to an arrangement method selected by a user or according to a preset arrangement method controlled by the controller 110. For example, the display unit 130 can display phone call logs, telephone numbers, images, videos, text messages, or the like, according to a preset arrangement method. In particular, the display unit 130 may classify a content list into groups according to a classification criterion when displaying the content list and may display the classified groups with different background colors under control of the controller 110. In particular, the display unit 130 can display, using a first color, the background of a content list included in a first group among the classified groups, and can display, using a second color, the background of a content list included in a second group. In some cases, the first color may be different from the second color. The display unit 130 can also display the background of a content list included in a third group with the first color, and the background of a content list included in a fourth group with the second color. The display unit 130 can change the background color of a content list from the first color to the second color or from the second color to the first color when a group is changed. Accordingly, a user can recognize the change of a group through the background color of a content list. A group may be changed when contents within the group are moved in and/or out of the group based on the classification criterion being used. However, exemplary embodiments of the present invention are not limited to displaying groups in two colors. In some cases, the background color of a content list for distinguishing groups can be set with three or more colors based on user preference. Furthermore, the background color of a content list may be changed on a group basis to distinguish each group, however, exemplary embodiments of the present invention are not limited thereto, and may provide various methods of enabling the user to visually recognize a change in the group. For example, a letter color, a letter size, a font, or light and darkness can be changed on a group basis, and shall be described in detail below with reference to the controller 110.

The storage unit 120 can store user data and programs for functional operations of the portable terminal 100. The storage unit 120 can include a program region and a data region.

The program region may store an Operating System (OS) to control overall operation of the portable terminal 100. The program region may also store programs for arranging content lists, classifying each content list into groups according to the classification criterion, and displaying the classified groups with different background colors. Furthermore, the program region can store a face recognition program for recognizing face characteristic information of a user in a photo, a program for extracting color information of an image, and a program for extracting GPS information. Detailed description of these programs shall be provided in further detail below.

The data region may store data generated due to use of the portable terminal 100. The data region can store contents and attribute information of the contents. The contents can include a phone call log, a telephone number, an image, a video, a text message, or the like. The attribute information can include date information, a title, a capacity, a file format, position information of a photographed place, a background color, a letter color, or the like. In particular, the data region can store classification criteria for classifying a content list into groups, as shown in TABLE 1. TABLE 1 shows an example of the arrangement methods and the classification criterion according to exemplary embodiments of the present invention.

TABLE 1

| Arrangement Method | Classification Criteria |
|---|---|
| Time | Date |
| Name | First Letter |
| Capacity | 1M |
| Type | File Format |
| Face Recognition | Face Characteristic Information |
| Color | Color Information |
| Photographed Place | GPS Information |
| Frequency of Use | Number of Times Used |

For example, referring to TABLE 1, if the arrangement method of the content list is based on time, the classification criterion may be “Date.” If the arrangement method is based on a name, the classification criterion may be “First Letter.” If the arrangement method is based on a capacity, the classification criterion may be “1M” (megabyte), or in some cases, may be “1K” (i.e., kilobyte), “1G” (i.e., gigabyte), or “1T” (terabyte).” If the arrangement method is based on a type, the classification criterion may be “File Format.” If the arrangement method is based on face recognition, the classification criterion may be “Face Characteristic Information.” If the arrangement method is based on color, the classification criterion may be “Color Information.” If the arrangement method is based on a photographed place, the classification criterion may be “GPS Information”. If the arrangement method is based on the frequency of use, the classification criterion may be “Number of Times Used.” Explanation of the method of displaying a content list according to a classification criterion is described below with reference to the controller 110.

Referring back to the storage unit 120, the data region can also store information of list background colors. For example, the data region can store information of a first color and a second color associated with the change of groups. For this purpose, the portable terminal 100 can include a list background color information setup menu.

The controller 110 can control an overall operation of the portable terminal 100, a signal flow between internal blocks, and a data processing function. The controller 110 can classify a content list into groups according to the classification criterion, and can cause the display unit 130 to display the classified groups with different background colors so that a user can easily recognize the content list. For example, referring back to TABLE 1, if a method of arranging a content list is based on time, the classification criterion may be a date. Accordingly, the controller 110 can check date information of the content list, and can classify the contents having the same date information into one group. Then, the controller 110 can cause the display unit 130 to display the background color of a first group, including contents having the most recent same date information, with a first color, and to display the background color of a second group having dates different than or after the dates associated with the first group (e.g., reverse chronological order) with a second color. In some cases, the controller 110 can cause the display unit 130 to display a third group with the first color, and to display a fourth group with the second color. That is, the controller 110 can use the two colors as the background color of groups. However, exemplary embodiments of the present invention are not limited to two colors, and multiple colors (e.g., three or more colors) may be used to display the background color of groups. Furthermore, for an arrangement method based on time, the classification criterion can be time information, and may not be limited to date information. For example, the classification criterion can be a certain range of time information, such as, for example, one hour, the forenoon, or afternoon.

If a method of arranging a content list is based on a name, the classification criterion may be a first letter. Accordingly, the controller 110 can check the first letter of each name of a content and can classify, into one group, contents associated with a name having the same first letter. Then, the controller 110, as described above, can cause the display unit 130 to display the classified groups with different background colors, thereby enabling the user to easily recognize that the first letter has changed. However, the arrangement method of name is not limited to a classification criterion of the first letter. In some cases, the classification criterion can be set to a second letter or a letter following the second letter according to the portable terminal user's preference or selection.

If a method of arranging a content list is based on capacity, the classification criterion may be 1M. Accordingly, the controller 110 can classify the content list into groups of 1M based on the contents having the greatest capacity, and can display the classified groups with different background colors. However, the arrangement method based on capacity is not limited to the to a classification criterion of grouping contents with 1M capacity.

If a method of arranging a content list is based on type, the classification criterion may be file format. Accordingly, the controller 110 can classify the content list into groups according to an extension of the files associated with the content. The classified groups can then be displayed with different background colors. However, the type arrangement method is not limited to the file format. For example, the classification criterion can be a content type, such as, for example, video, music, or a document. Accordingly, the controller 110 can classify contents having extensions, such as “avi,” “mov,” and “mpeg” (i.e., extensions corresponding to video content), into one group, and can classify contents having extensions, such as “mp3,” “wav,” “ogg,” and “mid” (i.e., extensions corresponding to music content), into one group. The storage unit 120 may store extension information corresponding to each content type.

If a method of arranging content lists is based on face recognition, the classification criterion may be face characteristic information. Accordingly, the controller 110 can recognize face characteristic information of one or more persons included in a photo content, and can classify the photo contents including the same person into one group. Thus, photo content (e.g., pictures), including a first person, may be displayed in a first color, and photo content (e.g., pictures), including a second person, may be displayed in a second color. Since face recognition methods are well known, a description of the facial recognition method is omitted. The storage unit 120 can store a face recognition program.

If a method of arranging a content list is based on color, the classification criterion may be color information. Accordingly, the controller 110 can extract color information which primarily occupies the photo content (e.g., the predominant color filling a photo content), and can classify the photo content having the same color information into one group. For example, the controller 110 can classify the photo content, including an evening glow, which may be primarily red, into one group, and can classify the landscape photo content, including the sea or the sky, which may be primarily blue, into one group.

If a method of arranging a content list is based on a photographed place, the classification criterion may be GPS information. Accordingly, the controller 110 can search attribute information of the photo content for GPS information, and can classify the photo contents which were taken in the same area and/or location into one group. The portable terminal 100 may include a GPS receiver to obtain GPS information. The portable terminal 100 can store position information of photographed places, together with photos, when the photos were taken. For example, the controller 110 can classify photos taken in the same region into one group based on the position information. The same region can be a town, a city, or the like, on the basis of an address.

If a method of arranging a content list is based on a frequency of use, the classification criterion may be the number of times the content has been used. Accordingly, the controller 110 can check the frequency of use of each content, and can classify one or more content having the same frequency of use into one group. In some cases, the controller 110 can classify the content having a given frequency of use (e.g., 10 times) on the basis of content having the highest frequency of use into one group. For example, if a highest number (e.g., 43) corresponds to the highest frequency of use for each content, the controller 110 can classify content having the frequency of use in a first range (e.g., 34 to 43) into a first group, and can classify content having the frequency of use in a second range (e.g., 24 to 33) into a second group. The first range may correspond to frequencies that are smaller than the highest number, but greater than frequencies corresponding to the second range. The second range may correspond to frequencies that are smaller than the frequencies in the first range. The storage unit 120 can accumulate and store the frequency of use of content.

As described above, the portable terminal 100 may classify content into groups according to the classification criterion and may display the classified groups with different background colors. Thus, a user can easily visually recognize if and when attribute information of the content according to the classification criteria has changed. For example, if a method of arranging content lists is based on time and a background color of the content list changes, a user can easily recognize that date information of the content list has changed. If, for example, a method of arranging a content list is based on a name, a user can easily recognize that the first letter of each content name has changed.

Furthermore, although not shown in the drawings, the portable terminal 100 can selectively include elements with supplementary functions, such as a camera module for acquiring photos or videos, a charging terminal for coupling with a charger, an input unit, and a wireless communication unit for conducting a voice call or video conference. It should be understood that additional elements may be included in the portable terminal 100, and that various modifications of the above-noted elements may be included in various ways in line with the enhancement of digital devices.

The schematic configuration of the portable terminal 100 has been described above with reference to FIG. 1. Hereinafter, a method of displaying a content list using the portable terminal is provided.

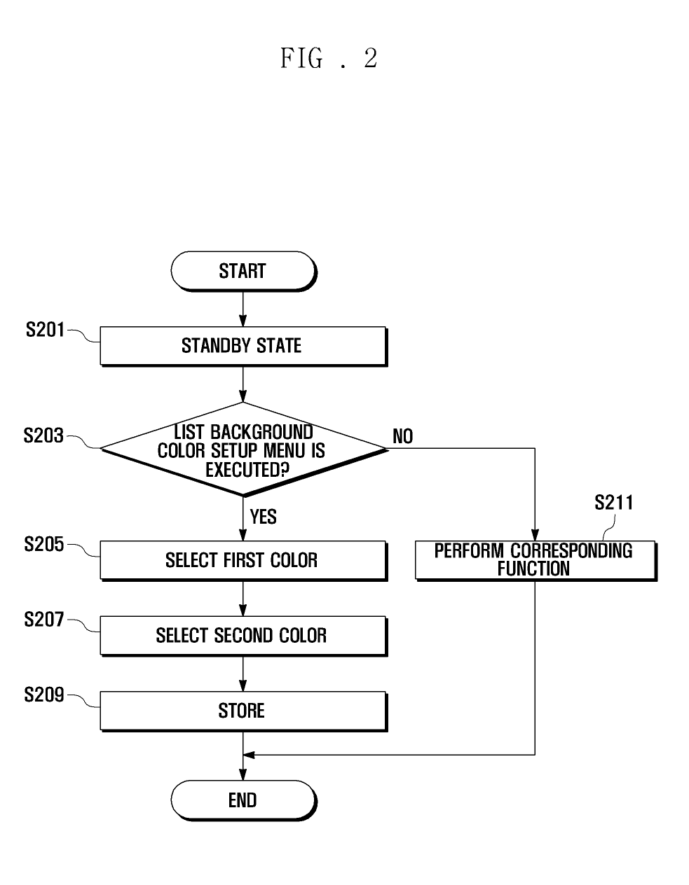

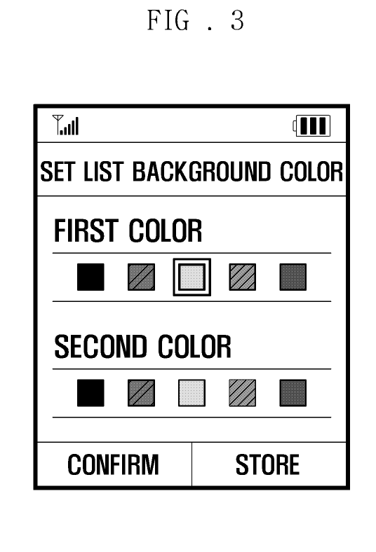

FIG. 2 is a flowchart schematically illustrating a method of setting up a list background color according to exemplary embodiments of the present invention. FIG. 3 is an exemplary view showing a screen for setting up a list background color according to exemplary embodiments of the present invention.

Referring to FIG. 2 and FIG. 3, the portable terminal can operate in a standby state after the portable terminal is supplied with power and booted (S201). Then, the controller can determine whether a signal of executing a list background color setup menu of a content list is generated (S203).

If the list background color setup menu has not been executed at step S203, the controller 110 can perform a corresponding function (e.g., playback of music files, acquiring/viewing photos, or writing text messages), or maintain the standby state (S211). However, if the list background color setup menu has been executed at step 203, the controller 110 can enable a user to select a first color (i.e., the background color of a first group) (S205). For example, the controller 110 can cause the display unit 130 to display a screen, as shown in FIG. 3, and can enable a user to select the first color through the direction key of an input unit (not shown), or a touch operation if a touch screen is included in the display unit 130. After the first color is selected, the controller 110 can enable the user to select a second color which may be different from the first color (S207). When the second color is selected, the controller 110 can prevent the user from selecting the same color as the first color. For example, in some cases, the controller 110 may not activate the second color having the same color as the first color, so that the user may not be able to select the second color. In some cases, a warning message may be displayed on the display unit 130 when the second color, having the same color as the first color, is selected. After selecting the second color, the user may activate a storage function using an input unit (not shown) or a touch screen. The controller 110 may then store the first color and the second color in the storage unit 120 (S209).

Although an example that the background color of a content list is set to the first color and the second color (i.e., two colors) has been described above, exemplary embodiments of the present invention are not limited to two colors. For example, the background color of a content list may be set to three or more colors according to a user's selection.

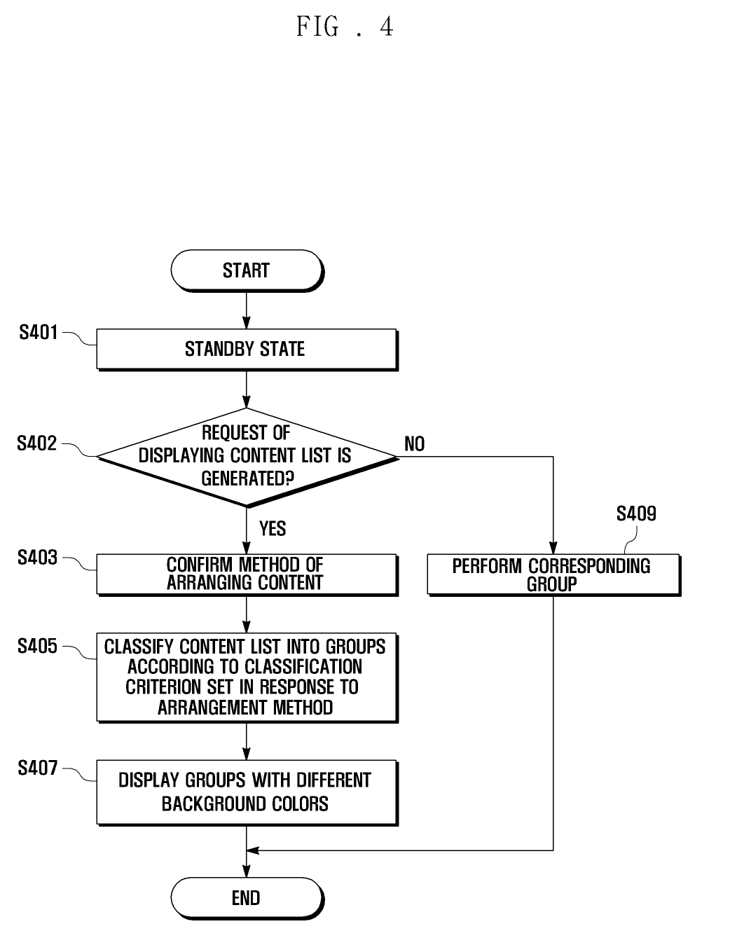

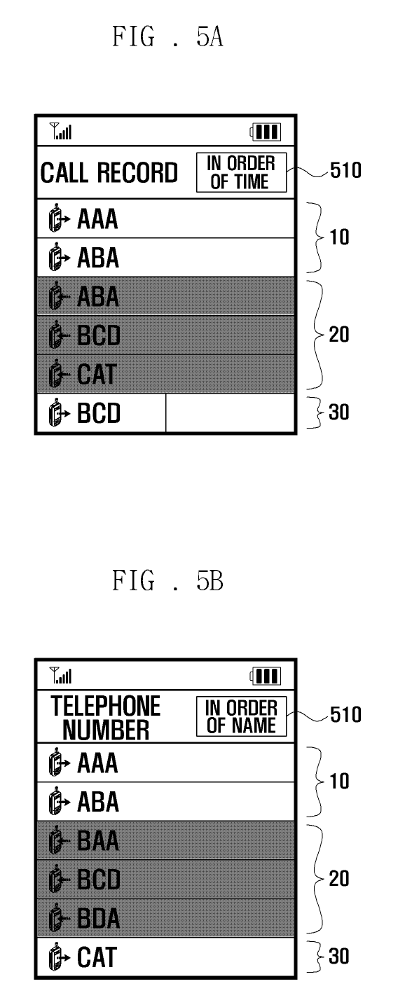

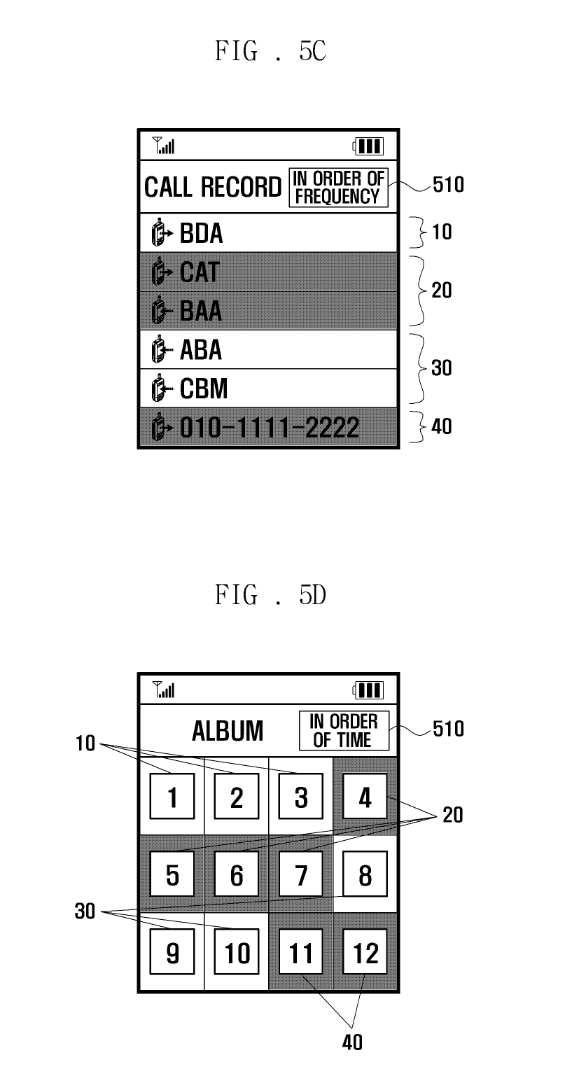

FIG. 4 is a flowchart illustrating a method of displaying a content list according to exemplary embodiments of the present invention. FIG. 5A, FIG. 5B, FIG. 5C, and FIG. 5D are exemplary views showing screens for classifying a content list into groups and displaying the classified groups according to exemplary embodiments of the present invention.

Referring to FIG. 4, FIG. 5A, FIG. 5B, FIG. 5C, and FIG. 5D, the portable terminal 100 may operate in a standby state after the portable terminal 100 is supplied with power and booted (S401). Then, the controller 110 can determine whether a request to display a content list is generated (S402). If, at step S402, a request to display a content list has not been generated, the controller 110 can perform a corresponding function (e.g., playback of music files, acquiring/viewing photos, or writing text messages) (S409), or maintain the standby state.

If, at step S402, a request to display a content list has been generated, the controller 110 may confirm that a method of arranging the content has been selected (S403). The arrangement method can be previously set, or can be changed by the user through an arrangement method selection menu 510, as shown in FIG. 5A, FIG. 5B, FIG. 5C, and FIG. 5D, and as described in further detail below. The arrangement method can be based, for example, on time, name, capacity, type, face recognition, color, photographed place, or frequency of use.

The controller 110 can confirm a classification criterion, which is previously set in response to the arrangement method, and can classify the content list into groups according to the classification criterion (S405). The classification criterion with reference to FIG. 4 may be the same as the classification criterion described above, and a repeated description of the classification criterion is omitted.

The controller 110 can cause the display unit 130 to display the classified groups with different background colors on the display unit (S407). The controller 110 can cause the display unit 130 to display the content list background of a first group 10 in a first color, the content list background of a second group 20 in a second color different from the first color, the content list background of a third group 30 in the first color, and the content list background of a fourth group in the second color. For example, the controller 110 can cause the display unit 130 to display the content list background of a group corresponding to an odd number in the first color and to display the content list background of a group corresponding to an even number in the second color. Displaying classified groups with different background colors is described in more detail with reference to FIG. 5A, FIG. 5B, FIG. 5C, and FIG. 5D.

FIG. 5A is an exemplary view showing a screen in which a content list is arranged and displayed in order of time according to exemplary embodiments of the present invention.

Referring to FIG. 5A, the display unit 130 can output a list of call records. The controller 110 can classify the call records into groups according to a classification criterion corresponding to a particular arrangement method. For example, in FIG. 5A, the arrangement method is based on time. The controller 110 can check the time when a call request of each call record is sent or received (since the classification criterion is a date), and can classify call records having the same date into one group. That is, the controller 110 can classify the call records into a first group 10 including “AAA” and “ABA,” a second group 20 including “ABA,” “BCD,” and “CAT,” and a third group 30 including “BCD.” The display unit 130 can display background colors of the first group 10 and the third group 30 in a first color, and a background color of the second group 20 in a second color. Accordingly, a user can immediately notice that the user called counterparts belonging to the same group on the same date and counterparts belonging to different groups on different dates (through a change in the color of each group) without checking the call time and date information. For example, a user can immediately realize that the user called a person “AAA” belonging to the first group 10 today, and a person “BCD” belonging to the second group 20 before today (e.g., yesterday).

FIG. 5B is an exemplary view showing a screen in which telephone numbers are arranged in the order of names according to exemplary embodiments of the present invention.

Referring to FIG. 5B, the display unit 130 can output a list of call records. The controller 110 can classify the call records into groups according to a classification criterion corresponding to an arrangement method based on the names of callers. For example, the controller 110 can classify “AAA” and “ABA” having the same first letter into a first group 10, “BAA,” “BCD,” and “BDA” having the same first letter into a second group 20, and “CAT” into a third group 30, since the classification criterion set in response to the arrangement method is a first letter. The display unit 130 can display background colors of the first group 10 and the third group 30 in a first color, and a background color of the second group 20 in a second color. Accordingly, a user can immediately recognize that the first letter of each content name changes through a change in the color of the content list background.

FIG. 5C is an exemplary view showing a screen in which a content list is displayed on the basis of frequency of use according to exemplary embodiments of the present invention.

Referring to FIG. 5C, the display unit 130 can display a list of call records, and the controller 110 can check the number of times each call record is called. A classification criterion may be set in response to the frequency of use, and can classify one or more call records having the same number of times called (i.e., call frequency) into one group. In some cases, the controller 110 can classify call records having the highest call frequency into one group. For example, if the highest call frequency is 10 times and the predetermined range to classify into the same group is 3 times, the controller 110 can classify call records having a call frequency of 8 to 10 into one group, and can classify call records having a call frequency of 5 to 7 into one group. For example, as shown in FIG. 5C, the controller 110 may classify “BDA” into a first group 10, “CAT” and “BAA” into a second group 20, “ABA” and “CBM” into a third group 30, and “010-1111-2222” into a fourth group 40, based on the frequency number of calls. The display unit 130 can display a background color of the first group 10 and the third group 30 in a first color, and a background color of the second group 20 and the fourth group 40 in a second color.

FIG. 5D is an exemplary view showing a screen in which an image content list is displayed according to exemplary embodiments of the present invention.

Referring to FIG. 5D, when a request of displaying an image content list is generated, the display unit 130 can display image content (e.g., a photo) in the form of thumbnail images as shown FIG. 5D. The controller 110 can confirm an arrangement method, and can classify the image content into groups according to a classification criterion corresponding to the arrangement method. For example, as shown in FIG. 5D, the controller 110 can classify images of numbers 1 to 3 in a first group 10, images of numbers 4 to 7 in a second group 20, images of numbers 8 to 10 in a third group 30, and images of numbers 11 and 12 in a fourth group 40. The display unit 130 can display background colors of the first group 10 and the third group 30 as a first color, and background colors of the second group 20 and the fourth group 40 as a second color.

It should be understood that although the background color of a content list is displayed using a first color and a second color (i.e., two colors), exemplary embodiments of the present invention are not limited to two colors, and the background color of a content list can be set to three or more colors according to a user's selection.

Furthermore, it should be understood that although a background color of a content list is changed to distinguish groups from one another, exemplary embodiments of the present invention are not limited to indicating differences just by color. For example, various methods of enabling a user to visually distinguish groups can be used including, for example, using different letter colors, letter sizes, fonts, or shades of light to differentiate one group from another.

Accordingly, when outputting a content list in a portable terminal 100, the content list may be classified into groups according to a classification criterion set in response to an arrangement method. The classified groups may then be displayed to be visually distinguishable from each other. Accordingly, a user can easily notice that content information is changed.

Although a portable terminal and a method of displaying a content list using the same according to the exemplary embodiments of the present invention have been described above with reference to the accompanying drawings, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of displaying a content list of a portable terminal, the method comprising:
setting an arrangement method of arranging the content list in response to a request for displaying the content list, the content list comprising a list of content;
classifying the content list into at least two groups according to a classification criterion associated with the arrangement method; and
displaying the content list,
wherein the at least two groups are visually distinguishable from each other.

2. The method of claim 1, wherein displaying the content list comprises differently displaying the at least two groups using at least one of a background color and a letter color.

3. The method of claim 2, wherein differently displaying the at least two groups comprises alternatively displaying two colors.

4. The method of claim 1, wherein the arrangement method comprises at least one of time, name, capacity, type, color, location where a photograph was taken, face recognition, and frequency of use.

5. The method of claim 4, wherein, if the arrangement method is based on time, classifying the content list into at least two groups comprises:
determining date information of the content; and
classifying content having the same date information in one group.

6. The method of claim 4, wherein, if the arrangement method is based on name, classifying the content list into at least two groups comprises classifying, in one group, content having a same first letter among titles of the content.

7. The method of claim 4, wherein, if the arrangement method is based on capacity, classifying the content list into at least two groups comprises:
determining the capacity of the content; and
classifying, in one group, content belonging to a given capacity range based on contents having the greatest capacity.

8. The method of claim 4, wherein, if the arrangement method is based on type, classifying the content list into at least two groups comprises:
determining extensions of the content; and
classifying content having the same extension in one group.

9. The method of claim 4, wherein, if the arrangement method is based on face recognition, classifying the content list into at least two groups comprises:
extracting face characteristic information of persons in the content; and
classifying content having the same face characteristic information in one group.

10. The method of claim 4, wherein, if the arrangement method is based on color, classifying the content list into at least two groups comprises:
extracting color information from the content; and
classifying content having the same color information in one group,
wherein the same color information is a dominant color information of the content.

11. The method of claim 4, wherein, if the arrangement method is based on location where a photograph was taken, classifying the content list into at least two groups comprises:
determining position information in the content; and
classifying content having the same position information in one group.

12. The method of claim 4, wherein, if the arrangement method is based on frequency of use, classifying the content list into at least two groups comprises at least one of:
determining a frequency of use of the content and classifying at least two contents having the same frequency of use in one group; and
classifying the content into one group comprising select content having frequencies of use associated with a previously set range of highest frequencies of use.

13. A portable terminal, comprising:
a controller to set an arrangement method and to classify a content list into at least two groups according to a classification criterion associated with the arrangement method in response to a request of displaying the content list, the content list comprising a list of content; and
a display unit to display the content list to visually distinguish the at least two groups from each other.

14. The portable terminal of claim 13, wherein to visually distinguish the at least two groups, the display unit differently displays at least one of a background color and a letter color of the at least two groups.

15. The portable terminal of claim 14, further comprising a storage unit to store the at least one of the background color and the letter color, and to store a list background color setup menu associated with the at least one of the background color and the letter color.

16. The portable terminal of claim 15, wherein the background color comprises a first color and a second color different than the first color, the letter color comprises the first color and the second color, and the display unit distinguishes the at least two groups by alternatively displaying the first color and the second color.

17. The portable terminal of claim 13, wherein the arrangement method comprises at least one of time, name, capacity, type, color, location where a photograph was taken, face recognition, and frequency of use.

18. The portable terminal of claim 17, wherein the controller is configured to:
if the arrangement method is based on time, determine date information of the content and classify content having the same date information in one group;
if the arrangement method is based on name, classify content having a same first letter in one group;
if the arrangement method is based on capacity, determine the capacity of the content, and classify, in one group, the content belonging to a capacity range corresponding to a greatest capacity;
if the arrangement method is based on a type, determine an extension of the content, and classify content having the same extension in one group;
if the arrangement method is based on face recognition, extract face characteristic information of a person in the content, and classify content having the same face characteristic information in one group;
if the arrangement method is based on color, extract color information which has a highest proportion in the content, and classify content having the same color information in one group, wherein the same color information is a dominant color information of the content;
if the arrangement method is based on a photographed place, determine position information in the content, and classify content having the same position information in one group; and
if the arrangement method is based on frequency, determine a frequency of use of the content, and classify at least two contents having the same frequency of use in one group, or classify the content into one group comprising select content having frequencies of use associated with a previously set range of highest frequencies of use.
